(19) United States
(12) Patent Application Publication
(10) Pub. No.: US 2016/0236136 A1
(43) Pub. Date: Aug. 18, 2016

(54) APPARATUS AND METHOD OF USING SOUND WAVES TO REDUCE SORBENT CONSUMPTION IN DRY SORBENT INJECTION AIR POLLUTION CONTROL SYSTEMS

(71) Applicant: Clyde Bergemann Power Group Americas Inc., Atlanta, GA (US)

(72) Inventor: Danny S. TANDRA, Cumming, GA (US)

(21) Appl. No.: 14/621,002

(22) Filed: Feb. 12, 2015

(51) Int. Cl. B01D 53/08; B01D 53/79; B01D 53/40

(52) U.S. Cl. CPC B01D 53/08; B01D 53/40; B01D 53/79; B01D 2252/10; B01D 2253/102; B01D 2257/302; B01D 2257/602

(57) ABSTRACT

Methods and systems for reducing emissions produced in a combustion system are described. A sorbent material is introduced into the emission gases flowing from the combustion system. Sound waves are also applied to the emission gases in the flow path. The sound waves can be introduced into the emission gas flow path at a location upstream from where the sorbent is introduced into the emission gas flow path. The sound waves can also be introduced into the emission gas flow path such that the sound waves travel in a downstream direction in the flow path. The emissions can include Hg and acid gases such as SO₂. The sorbent material can be trona or activated carbon. The sound waves enhance mixing of and mass transfer between the sorbent and pollutants in the gas thereby reducing the amount of sorbent necessary to reduce harmful emissions.

### BACKGROUND

1. Field

This application relates generally to air pollution control systems and methods, in particular, to the use of sound waves to reduce sorbent consumption in dry sorbent injection air pollution control systems and methods.

2. Background of the Technology

Present environmental regulations require that combustion processes such as coal fired boilers, waste-to-energy plants, biomass boilers, incinerators and other such combustion equipment control acid gas emissions. Acid gas emissions include emitted acidic elements such as sulfur dioxide, sulfur trioxide, hydrochloric acid, hydrogen fluoride, etc. produced from the combustion of various materials including but not limited to coal, waste materials, and biomass products.

The technology presently employed to control acid gas emissions includes injecting appropriate dry sorbent materials that react efficiently with these elements where injected into the gas stream. The sorbent materials react and neutralize the acid compounds to allow them to be removed later by filters installed downstream, such as fabric filters (baghouses). Typical sorbent materials used are calcium oxide, calcium hydroxide, sodium bicarbonate, sodium sesquicarbonate and other similar products. One commonly used sorbent material is trona (i.e., trisodium hydrogendicarbonate dihydrate) which has a chemical formula of Na₂CO₃.NaHCO₃.2H₂O.

The sorbent can be an activated carbon material such as an activated carbon powder which can be used to adsorb mercury in the flue gas stream. The use of sound waves in combination with the activated carbon adsorbent can be used to improve the efficiency of the activated carbon adsorbent.

To achieve efficient removal of acid gas constituents, the sorbent materials can be introduced into the flue gas stream through multiple lances that uniformly dispense the sorbent evenly across the entire gas stream to promote uniform mixing between the sorbent and the acid gas elements. However, mixing is frequently incomplete and quantities of sorbent well in excess of those theoretically necessary to neutralize the acid gases are therefore required.

Accordingly, there still exists a need for improved methods and systems for removing and/or neutralizing acid gases from the emissions of combustion processes in which a sorbent material is introduced into the emission gas stream.

### SUMMARY

A method for reducing emissions in flue gas produced in a combustion system having a flue gas duct defining a flow path from a combustion chamber to an exhaust downstream of the combustion chamber, the method comprising:

introducing a sorbent material into the flue gas in the flue gas duct at a first location;

generating sound waves in the flue gas duct; and

applying the sound waves to the flue gas containing the sorbent material in the flue gas duct;

wherein the sound waves enhance mixing and mass transfer of the sorbent and pollutants in the gas.

A method for reducing emissions produced in a combustion system having a gas flow path from a combustion chamber to an exhaust downstream of the combustion chamber, the method comprising:

introducing a sorbent material into the gas flow path at a first location;

generating sound waves; and

applying the sound waves to the flow stream at a second location;

wherein at least a portion of the generated sound waves travel downstream in the direction of gas flow; and

wherein the sound waves enhance mixing and mass transfer of the sorbent and pollutants in the gas.

A system for reducing emissions from a combustion process in a combustion chamber comprising:

a flue gas duct having a first opening in fluid communication with the combustion chamber and a second opening downstream of the first opening such that emissions from the combustion chamber flow through the flue gas duct in a gas stream from the first opening to the second opening;

a sorbent injection system adapted to inject a sorbent material into the gas stream at a first location in the flue gas duct;

one or more sound generators, wherein the one or more sound generators are adapted to introduce sound waves into the flow stream at a second location in the flue gas duct;

wherein the sound waves enhance mixing and mass transfer of the sorbent and pollutants in the gas.

These and other features of the present teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a schematic of an air pollution control system wherein sound waves are introduced into the emission gas stream upstream of the sorbent injection system.

FIG. 2 is a schematic of an air pollution control system wherein sound waves are introduced into the emission gas stream downstream of the sorbent injection system.

FIG. 3 is a schematic of an air pollution control system wherein sound waves are introduced into the emission gas stream both upstream and downstream of the sorbent injection system.

FIG. 4 is a photograph showing a test assembly used to measure the effect of sound waves on sorbent efficiency in a flue gas duct.

FIG. 5 is a schematic of a combustion system showing the location of sorbent injection in a flue gas duct between the furnace and a baghouse.

FIG. 6 is a graph showing the concentration of SO₂ as a function of time in a flue gas wherein dry sorbent injection is used in combination with sound waves of different frequencies directed either in the direction of gas flow or opposed to the gas flow.

### DESCRIPTION OF THE VARIOUS EMBODIMENTS

The presently disclosed subject matter relates generally to a system and method for applying sound waves to reduce sorbent consumption in air pollution control. The system and method may be embodied in many different forms and should not be construed as limited to the embodiments set forth herein; rather, these embodiments are provided so that this disclosure will be thorough and complete, and will fully convey the scope of the system and method to those skilled in the art.

Various illustrative embodiments of a system and method for applying sound waves to reduce sorbent consumption in air pollution control are provided herein. In general, many chemical reactions involved in the air pollution control are under mass transfer control. In this case, the rate limiting step of the reactions is not the chemical reaction itself, but the mass transfer of the sorbent (chemical reagents) to or from the reaction zone. In other words, the mass transfer (mainly through adsorption or absorption) has to occur before the chemical reaction between the sorbent and pollutant can take place. The chemical reaction changes the pollutant to a less harmful form. Classic examples are SO₂ scrubbing by means of Trona injection to form sodium sulfate. This series of reactions is shown schematically below.

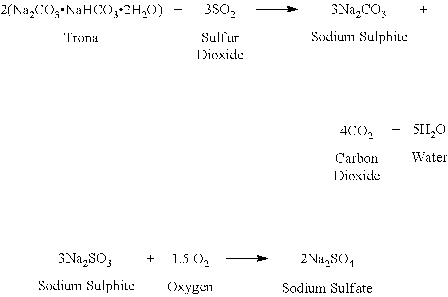

Sodium sulfate is generally regarded as a non-toxic material.

This kind of Dry Sorbent Injection (DSI) into the flue gas to capture air pollutants generally does not require significant capital investment. However, DSI has high operating costs because of the need to inject a large quantity of expensive sorbent to operate effectively.

Many strategies have been used to enhance the mass transfer of the sorbents such as through milling the sorbents in order to create very small particles and to increase the sorbent surface area per unit weight. Although this strategy has significantly reduced the sorbent consumption, the Normalized Stoichiometric Ratio (NSR) of the sorbent required to achieve effective pollutant removal is still considered very high. For example, the NSR of Trona injection required to achieve 90% of SO₂ removal can be as high as 4.0.

$$NSR = \frac{( \frac{Mass of Sorbent injected}{Mass of Flue Gas} )}{\begin{matrix}Mass of sorbent theoretically needed \\ to react with a unit mass of the flue gas\end{matrix}}$$

The main resistance to the mass transfer is generally located in the boundary layers adjacent to the interfaces between different phases. In case of dry sorbent injection, it is adjacent to the interfaces between the dry solid particle of the sorbent and the flue gas containing the air pollutants.

As set forth in the various illustrative embodiments provided herein, sound waves can be utilized to enhance mass transfer and to thereby reduce sorbent consumption in air pollution control applications. The utilization of sound waves is unique, effective, and economical. Sound waves can propagate through the flue gases without significant energy losses and effectively transfer the acoustic energy from a sonic transmitter (such as a sonic horn) to the interfaces between dry solid particles and the flue gas. The scattering and reflecting of the sound waves will produce acoustic streaming, acoustic radiation pressure and acoustically forced turbulence in the interfaces. All of these interface phenomena will directly enhance the mass transfer, intensify turbulent mixing between the sorbent and the flue gas containing the pollutants, and reduce the sorbent consumption.

The optimum amplitude and frequency of the sound waves can vary from site to site and the values depend on the field conditions such as particle size of the sorbent, gas temperature, and the geometry of the injection or reaction zones. These values can be obtained through field experiments or numerical simulation.

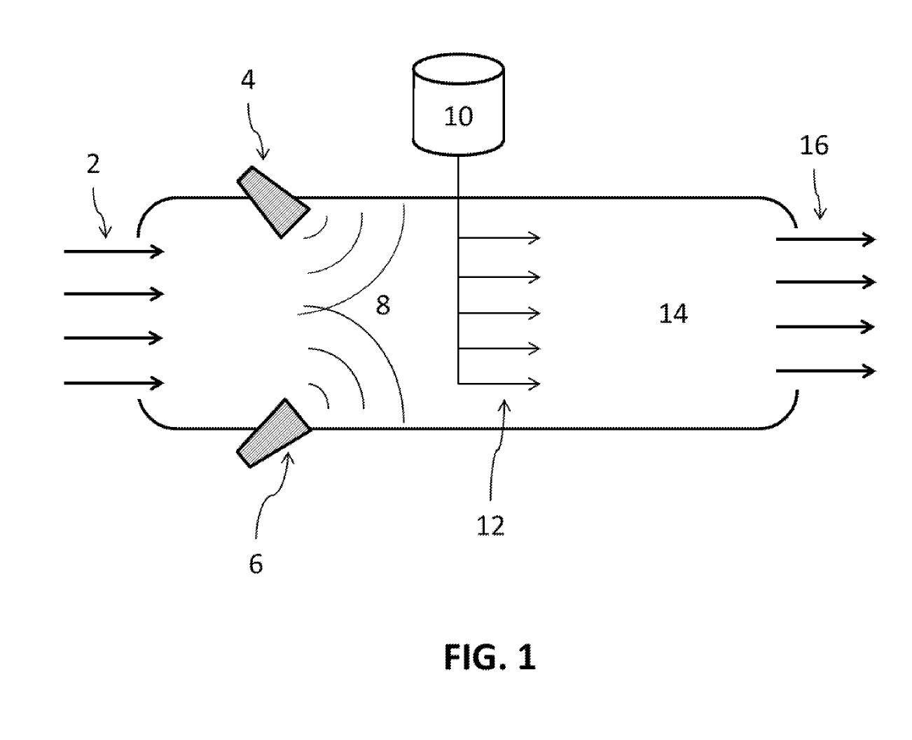

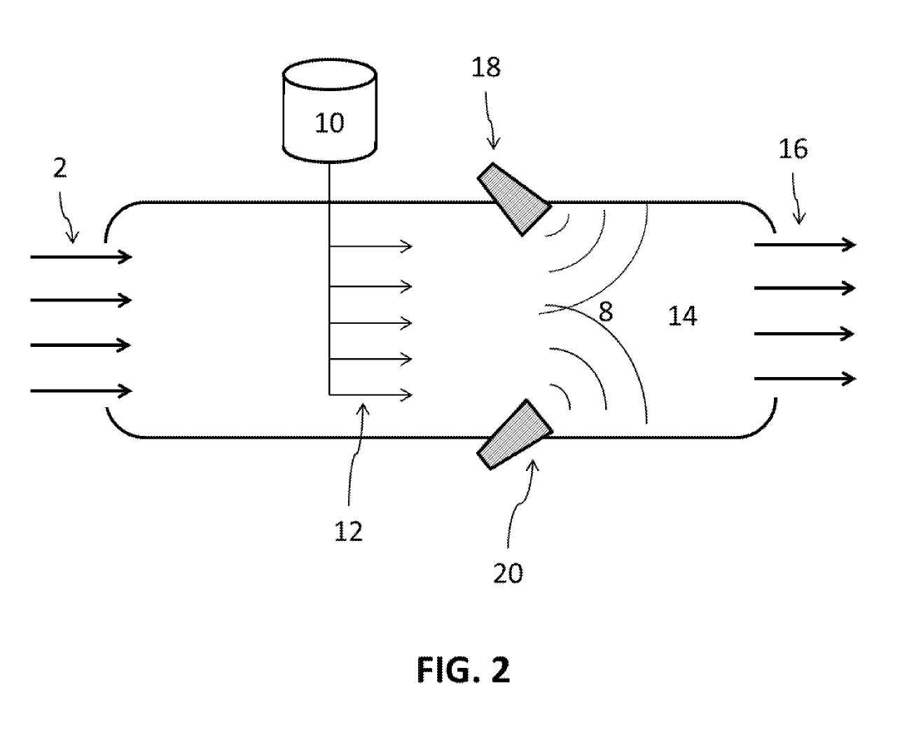

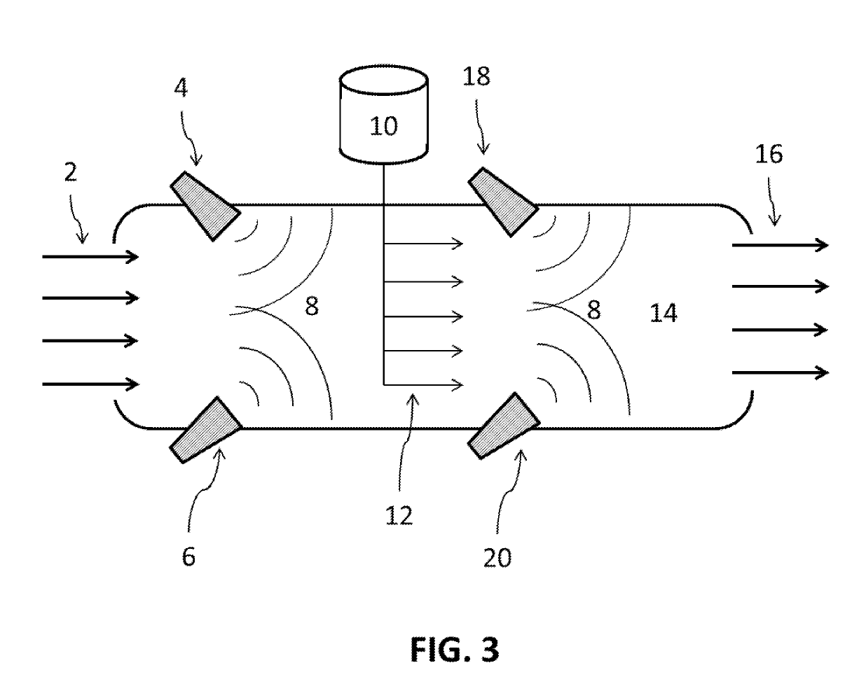

In various illustrative embodiments, the sound waves generator(s) can be located upstream (as shown in FIG. 1), downstream (as shown in FIG. 2), or both upstream and downstream (as shown in FIG. 3) of the sorbent injection system.

FIG. 1 is a schematic of an air pollution control system wherein sound waves are introduced into a combustion emission gas stream upstream of the sorbent injection system. As shown in FIG. 1, a combustion emission gas containing air pollutants flows 2 into an enclosure. Sound wave generators 4, 6 introduce sound waves 8 into the gas flow stream. As shown in FIG. 1, a dry sorbent injection system which includes lances 10 and a silo 8 containing a sorbent introduces the sorbent into the flow stream downstream of sound wave generators 4, 6. Sound waves 8 enhance the mixing and mass transfer of the sorbent and the pollutants in the flow stream downstream of the sorbent injection system. As a result, the gas emerging from the apparatus 16 is cleaner than the gas entering the apparatus 2. Although two sound generators are shown in FIG. 1, the system can include one or a plurality of sound generators upstream of the sorbent injection system. In addition, although the dry sorbent injection system depicted includes lances 10 and a silo 8 containing a sorbent, other methods of introducing sorbent material into the flow stream can be used.

FIG. 2 is a schematic of an air pollution control system wherein sound waves are introduced into a combustion emission gas stream downstream of the sorbent injection system. As shown in FIG. 2, a combustion emission gas containing air pollutants flows 2 into an enclosure. The system shown in FIG. 2 also includes a sorbent injection system which includes lances 10 for injecting sorbent into the flow stream and a silo 8 containing the sorbent material. As also shown in FIG. 2, sound wave generators 18, 20 introduce sound waves 8 into the flow stream downstream of the sorbent injection system. Sound waves 8 enhance the mixing and mass transfer of the sorbent and the pollutants in the flow stream. As a result, the gas emerging from the apparatus 16 is cleaner than the gas entering the apparatus 2. Although two sound generators are shown in FIG. 2, the apparatus can include one or a plurality of sound generators downstream of the sorbent injection system. In addition, although the dry sorbent injection system depicted in FIG. 2 includes lances 10 and a silo 8 containing a sorbent, other systems of introducing sorbent material into the flow stream can also be used.

FIG. 3 is a schematic of an air pollution control system wherein sound waves are introduced into the emission gas stream both upstream and downstream of the sorbent injection system. As shown in FIG. 3, a combustion emission gas containing air pollutants flows 2 into the apparatus. Sound wave generators 4, 6 introduce sound waves into the flow stream. The system shown in FIG. 3 also includes a sorbent injection system which includes lances 10 for injecting sorbent into the flow stream and a silo 8 containing a sorbent. As shown in FIG. 3, additional sound wave generators 18, 20 also introduce sound waves into the apparatus downstream of the sorbent injection system. Sound waves 8 enhance the mixing and mass transfer of the sorbent and the pollutants in the flow stream. As a result, the gas emerging from the apparatus 16 is cleaner than the gas entering the apparatus 2. Although four sound wave generators are shown in FIG. 3, the apparatus can include one or a plurality of sound generators upstream and downstream of the sorbent injection system. In addition, although the dry sorbent injection system depicted in FIG. 3 includes lances 10 and a silo 8 containing a sorbent, other systems of introducing sorbent material into the flow stream can be used.

To briefly summarize, without limitation, certain of the illustrative embodiments provided herein, a method for applying sound waves to reduce sorbent consumption in an air pollution control device for flue gas is provided, the method including the steps of providing an air pollution control device for flue gas, passing a combustion emission gas flow (e.g., a flu gas) through the air pollution control device, injecting a sorbent at a first location in the flue gas flowstream, and dispersing sound waves into the flue gas flowstream upstream of the first location. In other illustrative embodiments, the sound waves can be dispersed downstream of, or both upstream and downstream of, the first location.

Sound waves of various frequencies and intensities can be used. According to some embodiments, sound waves having frequencies of 50 to 200 Hz can be used. According to some embodiments, sound waves having frequencies of 100 to 200 Hz can be used. According to some embodiments, sound waves having intensities of 50 to 150 decibels can be used. The above examples are non-limiting and other frequencies and intensities can be used.

According to some embodiments, the adsorbent material is injected into the gas stream and the sound waves are applied to the gas stream in a flue gas duct. The section of the flue gas duct in which the adsorbent material is injected and the sound waves applied to the gas stream can have a uniform cross-section. The flu gas flow path both upstream from the location of adsorbent injection and downstream of the region where the sound waves are applied to the flow gas stream can have the same cross-section as the section of the flue gas duct where the sound waves are applied. The flue gas duct can be located between the combustion chamber (e.g., the furnace or other assembly where combustion takes place) and a particulate removal apparatus or separation means such as a baghouse or other particle collector. According to some embodiments, adsorbent material injection and sound wave application does not take place in either a combustion chamber or in a separator.

Although the use of trona (i.e., trisodium hydrogendicarbonate dihydrate) as an adsorbent material for acid gases is described above, other sorbent materials can also be used. Suitable sorbent materials for acid gases such as SO₂, SO₃ and HCl include, but are not limited to, calcium oxide, calcium hydroxide, sodium bicarbonate, hydrated lime and sodium sesquicarbonate. Suitable sorbents for Hg include, but are not limited to, activated carbon, silicate based sorbents such as AMENDED SILICATES®, supplied by Novinda Corporation of Denver, Colo., lime based sorbents, silica-lime-based sorbents, and mineral oxides.

### Experimental

In an effort to reduce the operational cost of using dry sorbent injection (DSI), research was conducted to improve the efficiency of DSI mixing by introducing sound waves into the flue gas stream. The goal was to reduce the amount of sorbent injected into the flue gas while achieving an equivalent reduction in harmful emissions.

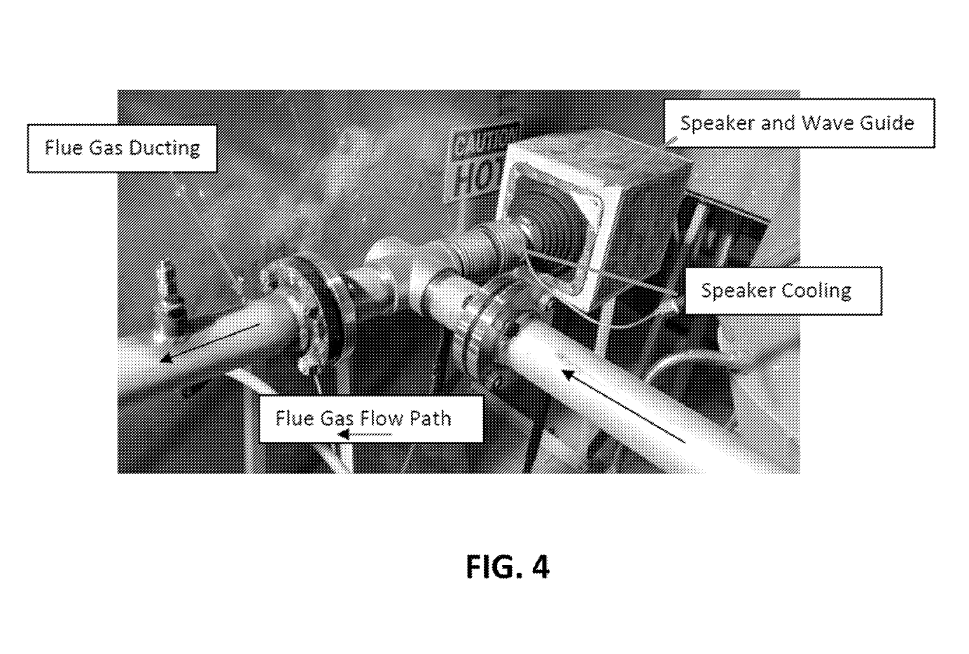

FIG. 4 is a photograph showing the test configuration. The flue gas ducting and the sound wave generator (i.e., speaker and wave guide) are shown in FIG. 4. The flue gas flow path is shown by the arrows along the flue gas duct sections. As shown in FIG. 4, the sound waves are directed in the direction of the flue gas flow. The test equipment can be reconfigured by mounting the sound wave generator such that the sound waves travel in the direction opposite to the flue gas flow. Both configurations were used to test the effect on sorbent efficiency.

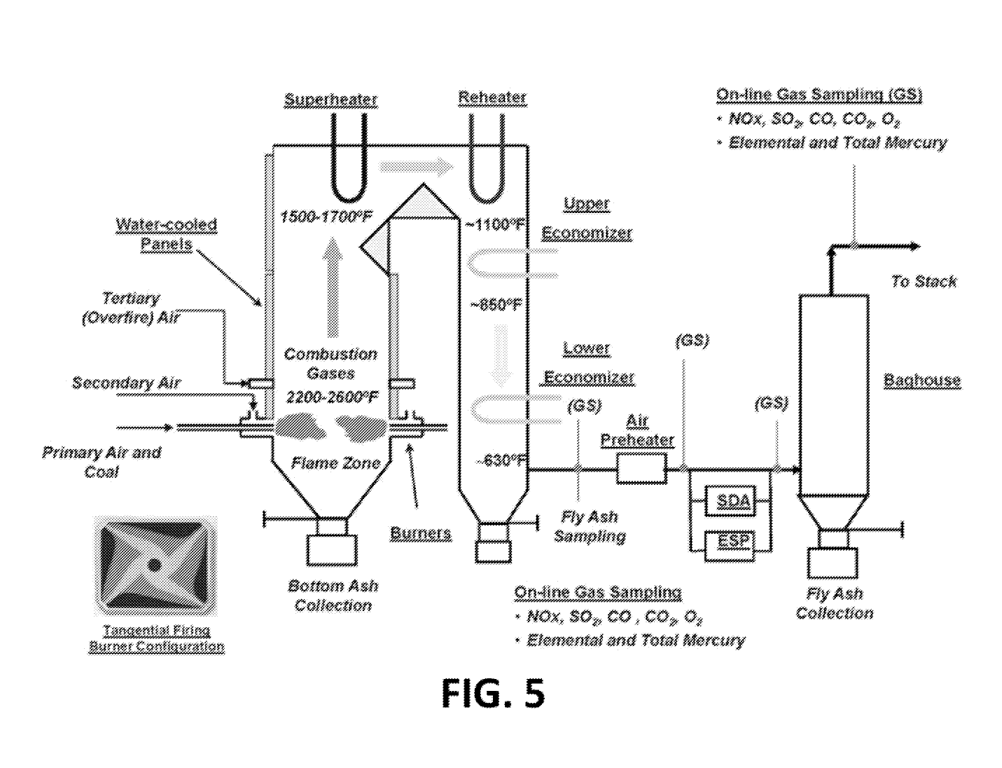

FIG. 5 is a schematic showing the location of the test equipment in a combustion system including a furnace and a baghouse. As can be seen from FIG. 5, the combustion system includes an air preheater, a spray drying absorption (SDA) device and an electrostatic precipitator (ESP) in the flue gas flow path from the furnace to the baghouse. The sorbent was injected after the air preheater and before the ESP. The sorbent used was hydrated lime. High sulfur bituminous coal was used as a fuel for the furnace. Gas sampling was conducted. The gases sampled include NO_{X}, SO₂, CO, CO₂ and O₂.

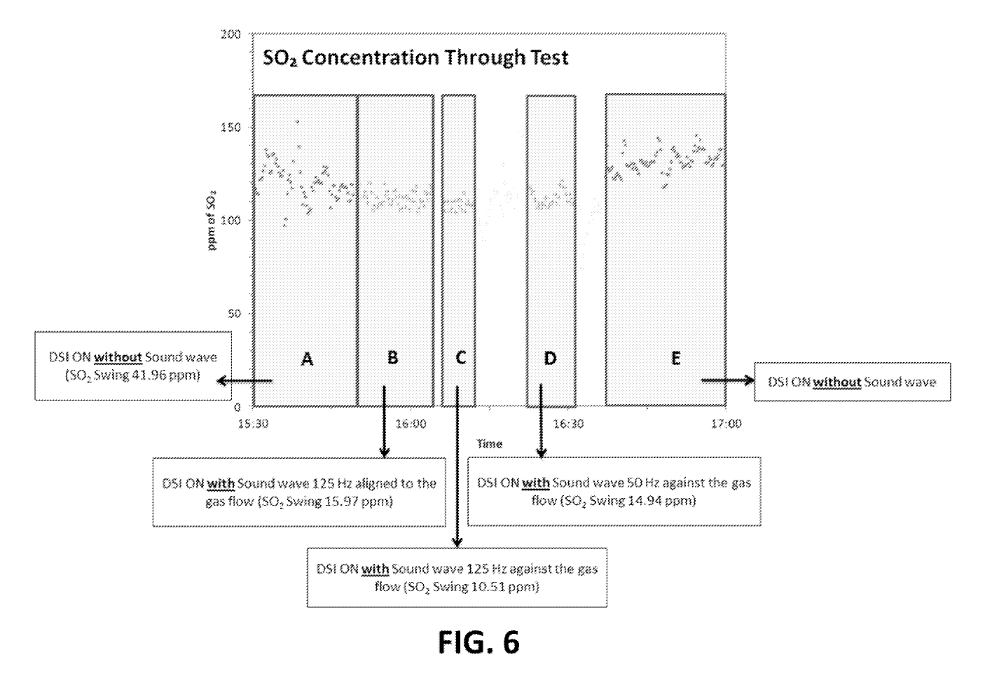

FIG. 6 is a graph showing the concentration of SO₂ (ppm) as a function of time during the test. During the portion of the test denoted as “A” in FIG. 6, dry sorbent injection (DSI), was employed without the application of sound waves. As shown in FIG. 6, the use of DSI alone resulted in a measured reduction in the concentration of SO₂ of 41.96 ppm. During the portion of the test denoted as “B” in FIG. 6, 125 Hz sound waves at 90 decibels were applied to the flue gas aligned to the gas flow. The use of the sound waves resulted in a measured reduction in the concentration of SO₂ of 15.97 ppm compared to test condition “A”. During the portion of the test denoted as “C” in FIG. 6, 125 Hz sound waves at 90 decibels were directed against the gas flow. The use of the 125 Hz sound waves against the gas flow in combination with DSI resulted in a measured reduction in the concentration of SO₂ of 10.51 ppm compared test condition “B” using DSI and sound waves directed in the direction of gas flow. During the portion of the test denoted as “D” in FIG. 6, 50 Hz sound waves at 90 decibels were directed against the gas flow in combination with DSI. The use of the 50 Hz sound waves directed against the gas flow combined with DSI resulted in a measured increase in the ppm of SO₂ of 14.94 ppm compared test condition “C” which used higher frequency 125 Hz sound waves directed against the gas flow combined with DSI. During the portion of the test denoted as “E” in FIG. 6, the sound waves were turned off again resulting in a significant increase in the SO₂ concentration in the flue gas flow stream.

As can be seen from FIG. 6, the use of 90 dB 125 Hz sound waves directed against the gas flow resulted in the highest efficiency of SO₂ removal (i.e., about 8% more SO₂ removal compared to baseline DSI without the use of sound waves).

While the foregoing specification teaches the principles of the present invention, with examples provided for the purpose of illustration, it will be appreciated by one skilled in the art from reading this disclosure that various changes in form and detail can be made without departing from the true scope of the invention.

What is claimed is:

1. A method for reducing emissions in flue gas produced in a combustion system having a flue gas duct defining a flow path from a combustion chamber an exhaust downstream of the combustion chamber, the method comprising:
introducing a sorbent material into the flue gas in the flue gas duct at a first location;
generating sound waves in the flue gas duct; and
applying the sound waves to the flue gas containing the sorbent material in the flue gas duct;
wherein the sound waves enhance mixing and mass transfer of the sorbent and pollutants in the gas.

2. The method of claim 1, wherein the second location is upstream from the first location in the flue gas flow path.

3. The method of claim 1, further comprising applying sound waves to the flue gas at a third location in the flow path upstream from the first location.

4. The method of claim 1, wherein the flue gas includes an acid gas and wherein the sorbent material reacts with the acid gas.

5. The method of claim 4, wherein the sorbent material comprises sodium sesquicarbonate dehydrate or NaHCO₃.

6. The method of claim 1, wherein the flue gas comprises Hg and wherein the sorbent material comprises a sorbent for Hg.

7. The method of claim 6, wherein the sorbent for Hg comprises activated carbon.

8. The method of claim 1, wherein at least a portion of the sound waves travel downstream in the direction of gas flow.

9. The method of claim 1, wherein the sound waves are directed against the flue gas flow from the combustion chamber to the filter.

10. A method for reducing emissions produced in a combustion system having a gas flow path from a combustion chamber to an exhaust downstream of the combustion chamber, the method comprising:
introducing a sorbent material into the gas flow path at a first location;
generating sound waves; and
applying the sound waves to the flow stream at a second location;
wherein at least a portion of the generated sound waves travel downstream in the direction of gas flow; and
wherein the sound waves enhance mixing and mass transfer of the sorbent and pollutants in the gas.

11. The method of claim 10, wherein the second location is upstream and/or downstream in the flow path from the first location.

12. The method of claim 10, wherein the emissions produced in the combustion system include an acid gas and wherein the sorbent material reacts with the acid gas.

13. The method of claim 12, wherein the sorbent material comprises sodium sesquicarbonate dehydrate or NaHCO₃.

14. The method of claim 10, wherein the emissions comprise Hg and wherein the sorbent material comprises a sorbent for Hg.

15. The method of claim 14, wherein the sorbent for Hg comprises activated carbon.

16. A system for reducing emissions from a combustion process in a combustion chamber comprising:
a flue gas duct having a first opening in fluid communication with the combustion chamber and a second opening downstream of the first opening such that emissions from the combustion chamber flow through the flue gas duct in a gas stream from the first opening to the second opening;
a sorbent injection system adapted to inject a sorbent material into the gas stream at a first location in the flue gas duct;
one or more sound generators, wherein the one or more sound generators are adapted to introduce sound waves into the flow stream at a second location in the flue gas duct;
wherein the sound waves enhance mixing and mass transfer of the sorbent and pollutants in the gas.

17. The system of claim 16, wherein the second location is upstream from the first location in the flow path.

18. The system of claim 16, wherein the second opening is in fluid communication with a filter system.

19. The system of claim 18, wherein the filter system is a bag house.

20. The system of claim 16, further comprising one or more additional sound generators, wherein the one or more additional sound generators are adapted to introduce sound waves into the gas stream at a third location downstream of the first location.

21. The system of claim 16, wherein the one or more sound generators are sonic horns.

22. The system of claim 16, wherein the one or more sound generators are adapted to introduce sound waves into the flue gas duct such that the sound waves travel in a downstream direction in the flow path.

23. The system of claim 16, wherein the one or more sound generators are adapted to introduce sound waves into the flue gas duct at one or more locations upstream and/or downstream from the first location.
